(19) United States
(12) Patent Application Publication
(10) Pub. No.: US 2009/0222231 A1
(43) Pub. Date: Sep. 3, 2009

(54) Method and device for correcting a signal of a sensor

(76) Inventors: Joachim Berger, Winterbach (DE); Roland Klatt, Untergruppenbach (DE); Reinhold Danner, Rottenburg (DE); Heinrich Barth, Leonberg (DE); Anndreas Pfaeffle, Wuestenrot (DE); Rainer Strohmaier, Stuttgart (DE); Thomas Bleile, Stuttgart (DE); Michael Scheidt, Stuttgart (DE); Matthias Illing, Palo Alto, CA (US); Wolfgang Dressler, Vaihingen (DE); Torsten Handler, Stuttgart (DE); Christof Rau, Shanghai (CN); Thomas Pauer, Freiberg (DE); Gottfried Flik, Leonberg (DE); Udo Schulz, Vaihingen (DE); Wolfgang Fischer, Gerlingen (DE); Matthias Schueler, Steinheim (DE); Jan Bahlo, Farmington Hills, MI (US); Jean-Pierre Hathout, Bornova (TR)

Correspondence Address: KENYON & KENYON LLP, ONE BROADWAY, NEW YORK, NY, 10004, US

(21) Appl. No.: 11/921,831

(22) PCT Filed: May 15, 2006
(86) PCT No.: PCT/EP2006/062305

§ 371 Date: Mar. 6, 2009

(30) Foreign Application Priority Data
Jun. 6, 2005 (DE) 10 2005 025 884.0

(51) Int. Cl. G06F 19/00

(52) U.S. Cl. 702/104

(57) ABSTRACT

A method and a device for correcting a signal of a sensor provide for maximally accurate drift compensation of a characteristics curve of the sensor. At least one characteristic quantity of the signal of the sensor is compared with a reference value. The signal of the sensor is corrected as a function of the comparison result. A value of the at least one characteristic quantity of the signal of the sensor derived from the signal of the sensor is formed as the reference value.

### FIELD OF THE INVENTION

The present invention is directed to a method and a device for correcting a signal of a sensor.

### BACKGROUND INFORMATION

It is understood, for example, that in the case of a hot film air mass flow meter installed in an air supply of an internal combustion engine, the drift occurring over the lifetime of the hot film air mass flow meter is corrected by comparing the signal of the hot film air mass flow meter with an air mass flow value modeled from a boost pressure, a charge air temperature, and an engine speed as a reference value.

Since the charge pressure sensor for ascertaining the boost pressure, the temperature sensor for ascertaining the charge air temperature, and the rotational speed sensor for ascertaining the engine speed are each subject to tolerances, the accuracy of drift compensation achievable with the known method is less than the factory-new part tolerance of the unsoiled air mass flow meter.

Furthermore, DE 100 63 439 A1 discusses performing on-board diagnoses regarding predefinable plausibility criteria concerning the offset drift and/or the sensitivity drift of the sensor in addition to a signal range check, for example, for a sensor designed as a hot film air mass flow meter.

### SUMMARY OF THE INVENTION

The method according to the present invention and the device according to the present invention for correcting a signal of a sensor, having the features of the independent claims, have the advantage over the related art that at least one characteristic quantity of the sensor signal is compared to a reference value and the sensor signal is corrected as a function of the comparison result, a value of the at least one characteristic quantity of the sensor signal derived from the sensor signal being formed as the reference value. In this way, both the use of equivalent signals for modeling the sensor signal, i.e., the at least one characteristic quantity, and the modeling of the sensor signal itself may be dispensed with and an increased accuracy of the drift compensation is achieved by merely using the sensor signal for forming the reference value.

The measures described herein make advantageous improvements on and refinements of the basic method described herein.

It is advantageous in particular if the reference value is formed in a predefined operating state of the sensor, in particular within a predefined time after the sensor is put in service for the first time. In this way, the accuracy of the drift compensation of the sensor signal may be increased. In the most favorable case, the accuracy of the drift compensation is only affected by the factory-new part tolerance of the unsoiled sensor.

Another advantage results if a performance quantity of a drive unit, in particular of an internal combustion engine, is detected by the sensor and if the reference value and/or the at least one characteristic quantity of the sensor signal is formed for comparison with the reference value in at least one predefined operating state of the drive unit, in particular in an idling state. In this way, the accuracy of the drift compensation may be further increased, in particular by taking into account the time constant existing at the time when the measured value is detected by the sensor.

It is advantageous in particular if an air mass flow measuring device, in particular a hot film or ultrasonic air mass flow meter, is selected as the sensor. This permits the most accurate possible drift compensation to be performed for such an air mass flow measuring device.

A time-average and/or a signal amplitude of the sensor signal is/are suitable in particular as the at least one characteristic quantity of the sensor signal. From these two quantities, an offset and a sensitivity of a sensor characteristics curve for converting the sensor signal into the measured quantity to be detected may be corrected in a simple and reliable manner.

The sensor signal may be corrected in a particularly simple manner by forming, as a function of the comparison result, at least one correction value using which the sensor signal is corrected.

To ascertain the most reliable and error-free correction value possible, it may be advantageously provided that the at least one correction value be formed only in the case of a sensor signal recognized as plausible, in particular as a function of its variation over time.

The sensor signal may be corrected in a particularly simple manner by forming the at least one correction value as a correction value for an offset and/or as a correction value for a sensitivity of the sensor signal.

In particular in the case of a non-linear characteristics curve, it is advantageous if the at least one correction value is formed differently in different ranges of the signal quantity. This permits the most accurate possible drift compensation to be implemented even in the case of a non-linear sensor characteristics curve, specifically for multiple ranges of this characteristics curve, in particular for the entire characteristics curve.

Exemplary embodiments and methods of the present invention are depicted in the drawings and elucidated in greater detail in the description that follows.

### BRIEF DESCRIPTION OF THE DRAWINGS

FIG. 1 shows a block diagram of a section of a drive unit designed as an internal combustion engine.

FIG. 2 shows a reference characteristics curve and a drift characteristics curve, different therefrom, of an air mass flow meter.

FIG. 3 shows a function diagram for elucidating the method according to the present invention and the device according to the present invention.

FIG. 4 shows a flow chart for an exemplary sequence of the method according to the present invention.

### DETAILED DESCRIPTION

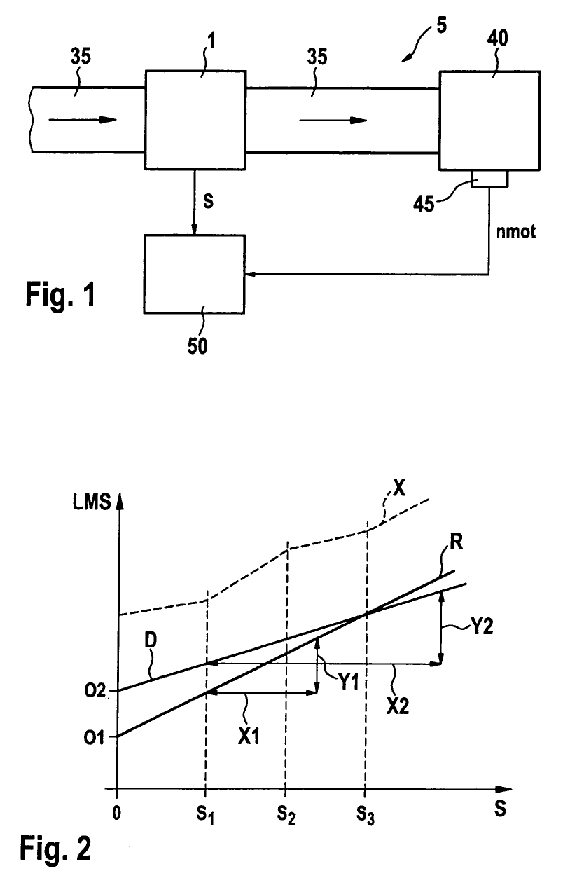

In FIG. 1, reference numeral 5 indicates by way of example a drive unit designed as an internal combustion engine having a cylinder block 40 which is supplied with fresh air via air supply 35. Internal combustion engine 5 may drive a gasoline engine or a diesel engine, for example. An air mass flow meter 1, for example, in the form of a hot film air mass flow meter or an ultrasonic air mass flow meter, is situated in air supply 35. Furthermore, a rotational speed sensor 45 is situated in the area of cylinder bank 40, which detects, as known to those skilled in the art, an engine speed nmot at predefined, equidistant sampling points and relays the corresponding measured values to a controller 50. Air mass flow meter 1 generates, also as known to those skilled in the art, a signal S on the basis of the air mass flow in air supply 35 also in the form of discrete measured values over time, these measured values being in turn detected at equidistant points in time. Signal S of air mass flow meter 1 is also relayed to controller 50. Further components provided, as known to those skilled in the art, or required for the operation of the internal combustion engine, but which are not required for understanding the exemplary embodiments and/or exemplary methods of the present invention are not depicted in FIG. 1 for reasons of clarity.

Controller 50 converts signal S of air mass flow meter 1 into the physical quantity of air mass flow LMS with the aid of a characteristics curve. FIG. 2 shows two such characteristics curves which are stored in controller 50, and in which air mass flow LMS is plotted against signal S of air mass flow meter 1. Both depicted characteristics curves are linear in this example. This represents a simplification of the actual relationship between signal S and air mass flow LMS, which in the case of air mass flow meter 1 being designed as an ultrasonic air mass flow meter corresponds more, and in the case of air mass flow meter 1 being designed as a hot film air mass flow meter corresponds less to reality, but in the following it will be used as a basis for elucidating the method according to the present invention and the device according to the present invention. Here R denotes a reference characteristics curve having a first offset value O1 and a first characteristics curve slope or sensitivity Y1/X1.

Furthermore, the diagram of FIG. 2 shows a drift characteristics curve D, which has a second offset O2 and a second slope or sensitivity Y2/X2, where O1≠O2 and Y1/X1≠Y2/X2. In this example it should be assumed that reference characteristics curve R represents the mapping of signal S of air mass flow meter 1 onto air mass flow LMS in a factory-new condition of air mass flow meter 1 in which air mass flow meter 1 is unsoiled. In contrast, drift characteristics curve D describes the mapping of signal S of air mass flow meter 1 onto air mass flow LMS at a later point in time, at which air mass flow meter 1 already has a certain amount of soiling which results in a higher offset compared to the reference characteristics curve, i.e., O2>O1 and which, compared to reference characteristics curve R results in a lower sensitivity or slope, i.e., Y2/X2<Y1/X1. Drift characteristics curve D thus results due to the soiling of air mass flow meter 1. Additionally or alternatively, drift characteristics curve D may also result due to the aging of air mass flow meter 1 and the wear associated therewith.

Signal S of air mass flow meter 1 has, as a function of the number of cylinders of cylinder bank 40 and engine speed nmot, pulsations which are superimposed on the time-average of signal S of air mass flow meter 1. Due to the soiling of air mass flow meter 1, over the lifetime of air mass flow meter 1, offset and sensitivity drifts, i.e., slope drifts, occur in the characteristics curve of air mass flow meter 1, which maps the signal of air mass flow meter 1 onto the physical quantity of the air mass flow. These offset and sensitivity drifts result in a shift of the time-average of air mass flow LMS resulting from the above-mentioned characteristics curve and in a change in its pulsation amplitude.

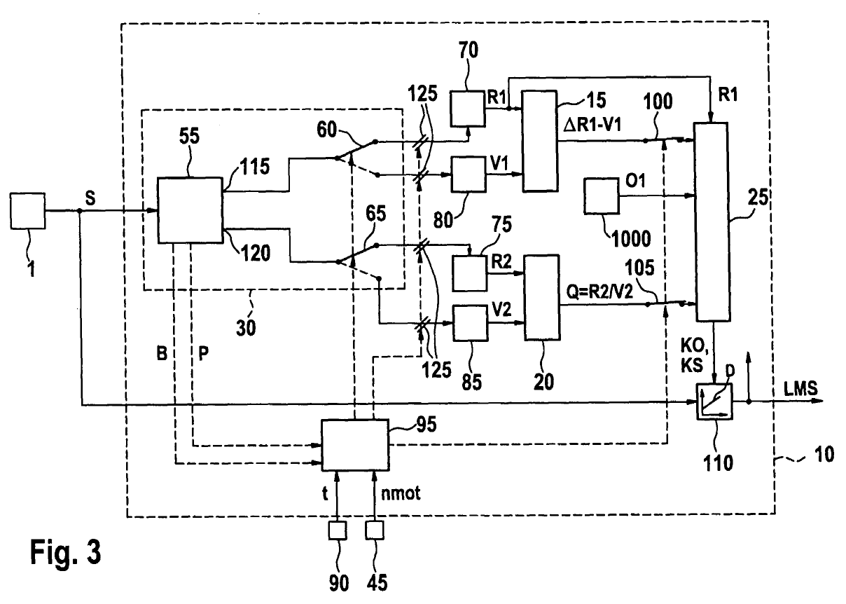

The objective is to convert signal S of air mass flow meter 1 as accurately as possible into air mass flow LMS at any point in time, i.e., which may be to determine the instantaneous drift characteristics curve D at any point in time. For this purpose, controller 50 includes a device 10 according to the function diagram of FIG. 3. Device 10 may be implemented, for example, as software and/or hardware in controller 50. Device 10 may also be identical to controller 50, i.e., controller 50 may form an appropriate control unit. This control unit may be identical to or different from an engine control unit.

Device 10 includes a reference value forming unit 30 having an analyzer unit 55, a first controlled switch 60, and a second controlled switch 65. Device 10 also includes an operating state detection unit 95, to which engine speed nmot detected by rotational speed sensor 45 and time t since first startup of air mass flow meter 1 detected by a time detection unit 90 are supplied. Time t may also correspond to the time elapsed since the first startup of internal combustion engine 5 if this time coincides with the time of the first startup of air mass flow meter 1. Time detection unit 90 may be a part of device 10 or, as depicted in FIG. 3, be situated outside device 10. The switching positions of first controlled switch 60 and second controlled switch 65 are triggered by operating state detection unit 95. This triggering takes place as a function of time t and engine speed nmot which characterize the operating state of internal combustion engine 5.

Device 10 also includes an instantaneous drift characteristics curve D, which is labeled with the reference numeral 110. Signal S of air mass flow meter 1 is supplied to the input side of both analyzer unit 55 and drift characteristics curve 110. Drift characteristics curve D is corrected by a correction unit 25 of device 10. This takes place with the aid of a first correction value KO for the offset of drift characteristics curve 110 and a second correction value KS for the slope or sensitivity of drift characteristics curve 110. At the output of drift characteristics curve 110, air mass flow LMS then appears, which is issued by device 10 for internal and/or external further processing. The output signal of a first comparator unit 15 may be supplied to correction unit 25 via a third controlled switch 100 and the output signal of a second comparator unit 20 may by supplied to said correction unit via a fourth controlled switch 105. The two comparator units 15, 20 are also part of device 10. In first comparator unit 15, the output signal of a first reference value memory 70 is compared to the output signal of a first comparison value memory 80, and in second comparator unit 20, the output signal of a second reference value memory 75 is compared with the output signal of a second comparison value memory 85.

The two reference value memories 70, 75 and the two comparison value memories 80, 85 are situated in device 10 in the example of FIG. 3. First controlled switch 60 connects a first output 115 of analyzer unit 55 either to an input of first reference value memory 70 or to an input of first comparison value memory 80. Second controlled switch 65 connects a first output 120 of analyzer unit 55 either to an input of second reference value memory 75 or to an input of second comparison value memory 85. Third controlled switch 100 and fourth controlled switch 105 are also triggered by operating state detection unit 95 as a function of the operating state of internal combustion engine 5.

First controlled switch 60 is connected by operating state detection unit 95 to connect first output 115 of analyzer unit 55 to the input of first reference value memory 70 when time t is less than a predefined limit time tlimit and engine speed nmot is less than a predefined engine speed nmotlimit. Otherwise operating state detection unit 95 triggers first controlled switch 60 to connect first input 115 of analyzer unit 55 to the input of first comparison value memory 80. Similarly, second controlled switch 65 is triggered by operating state detection unit 95 to connect second output 120 of analyzer unit 55 to the input of second reference value memory 75 when t<tlimit and nmot<nmotlimit. Otherwise, second controlled switch 65 is triggered by operating state detection unit 95 to connect second output 120 of analyzer unit 55 to the input of second comparison value memory 85.

Predefined time tlimit may be suitably calibrated on a test bench in such a way that for times t<tlimit no soiling of air mass flow meter 1 is to be expected. tlimit may be derived in particular from empirical values of air mass flow meters of the same type. Limit value nmotlimit for the engine speed may also be suitably calibrated on a test bench in such a way that engine speeds nmot<nmotlimit characterize an idling state of internal combustion engine 5. In principle, limit value nmotlimit for the engine speed should be advantageously calibrated in such a way that the time constant of air mass flow meter 1 which may be up to 15 ms is taken into account when detecting the air mass flow. Limit value nmotlimit for the engine speed may be calibrated in such a way that for engine speeds nmot<nmotlimit the air mass flow detection by air mass flow meter 1 is not or only negligibly distorted due to the time constant of air mass flow meter 1, but the air mass flow measurement for engine speeds nmot>nmotlimit is distorted to an undesirably high degree.

This ensures that first reference value memory 70 and second reference value memory 75 are written to or overwritten only in an operating state of internal combustion engine 5 in which substantial soiling of air mass flow meter 1 is not expected. In addition, this ensures that first reference value memory 70 and second reference value memory 75 are written to or overwritten only in an operating state of internal combustion engine 5 in which the measurement result of air mass flow meter 1 is not distorted by an excessive engine speed above or at limit speed nmotlimit.

Third switch 100 is closed by operating state detection unit 95 for connecting the output of first comparator unit 15 to correction unit 25 if nmot<nmotlimit and t>tlimit. Otherwise third controlled switch 100 is opened by operating state detection unit 95. Fourth controlled switch 105 is closed by operating state detection unit 95 for connecting the output of second comparator unit 20 to correction unit 25 if nmot<nmotlimit and t>tlimit. Otherwise fourth controlled switch 105 is opened by operating state detection unit 95.

First comparison value memory 80 and second comparison value memory 85 are written to or overwritten only in those operating states in which first reference value memory 70 and second reference value memory 75 may not be written to or overwritten due to the switch position of first controlled switch 60 and second controlled switch 65. Alternatively it may also be provided that first comparison value memory 80 and second comparison value memory 85 are written to or overwritten in principle in any desired state of internal combustion engine 5.

The two correction values KO and KS are updated in correction unit 25 only as long as both controlled switches 100, 105 are in the closed position as depicted in FIG. 3. If both switches 100, 105 are open, correction values KO, KS are not updated by correction unit 25. Drift characteristics curve 110 is always corrected using the latest updated correction values KO, KS. As FIG. 3 shows, the two switches 60, 65 are triggered synchronously by operating state detection unit 95. The same applies to the two controlled switches 100, 105.

Using the two controlled switches 100, 105 it is ensured that correction unit 25 updates the two correction values KO, KS only if engine speed nmot<nmotlimit and time t>tlimit. Drift characteristics curve 110 may be initially predefined in the form of reference characteristics curve R according to the specifications of the manufacturer of air mass flow meter 1 or on the basis of a calibration measurement and stored in device 10. This drift characteristics curve 110 is not corrected until the predefined time tlimit after the first startup of air mass flow meter 1 or of internal combustion engine 5 has elapsed and under the condition that engine speed nmot is less than the predefined limit speed nmotlimit, i.e., the correction is not distorted due an excessive speed higher than or equal to limit speed nmotlimit. In other words, the time constant in the air mass flow detection by air mass flow meter 1 is also taken into account in the correction of drift characteristics curve 110 to avoid errors in correcting drift characteristics curve 110.

Analyzer unit 55 analyzes signal S of air mass flow meter 1 regarding at least one characteristic quantity of this signal S. In the present example, analyzer unit 55 analyzes signal S of air mass flow meter 1 regarding two characteristic quantities of signal S. Analyzer unit 55 determines a time-average of signal S as a first characteristic quantity of signal S and outputs it as a moving average value at its first output 115. Furthermore, analyzer unit 55 ascertains the instantaneous value of the signal amplitude of signal S as a second characteristic quantity of signal S and outputs it at its second output 120.

Depending on the switch position of first controlled switch 60, the instantaneous moving time-average of signal S is stored in first reference value memory 70 or in first comparison value memory 80. Similarly, depending on the position of second controlled switch 65, the instantaneous value of the signal amplitude of signal S is stored in second reference value memory 75 or in second comparison value memory 85. First comparator unit 15 compares the moving average value of signal S, stored in first reference value memory 70, with the moving time-average stored in first comparison value memory 80, for example, by forming the difference or by division, and, in the case of the closed third switch 100, relays the result of the comparison, i.e., the difference or the quotient, to correction unit 25. Similarly, second comparator unit 20 compares the value of the signal amplitude in second reference value memory 75 with the value of the signal amplitude in second comparison value memory 85, for example, by forming the difference or the quotient, and relays the result of the comparison in the form of the difference or quotient to correction unit 25 provided second controlled switch 105 is in its closed position.

Initially, first reference value memory 70 and first comparison value memory 80 may have the same stored value, so that first comparator unit 15 outputs the value zero at its output as the comparison value in the case of difference formation. Similarly, initially second reference value memory 75 and second comparison value memory 85 may have the same stored value, so that second comparator unit 20 outputs the value 1 at its output as the comparison value in the case of quotient formation. In general, it may be provided that in the case where the two particular input quantities have the same magnitude, first comparator unit 15 outputs the value zero at its output and second comparator unit 20 outputs the value 1 at its output. If correction unit 25 receives the value zero from first comparator unit 15 and the value 1 from second comparator unit 20, it does not update the two correction values KO, KS. This corresponds to a state in which switches 100, 105 are open. Correction value KO for the offset may be initially set to the value zero and correction value KS for the slope, i.e., the sensitivity, may be initially set to the value 1.

Drift characteristics curve 110 is corrected by adding the offset of drift characteristics curve 110 to first correction value KO, and the slope of drift characteristics curve 110 is corrected by multiplying by second correction value KS. Alternatively, the offset may be corrected in any other way, for example, by multiplication, division, or subtraction, and the slope of drift characteristics curve 110 also may be corrected alternatively in any other form, for example, by addition, subtraction, or division. The type of correction of the offset and slope of drift characteristics curve 110 should, however, be established in advance and advantageously kept unchanged. Depending on the selected correction operation, i.e., addition, subtraction, division, or multiplication, correction values KO, KS are to be initialized in order not to modify drift characteristics curve 110 initially.

In FIG. 3, the output of first reference value memory 70 is labeled R1, the output of first comparison value memory 80 is labeled V1, the output of second reference value memory 75 is labeled R2, and the output of second comparison value memory 85 is labeled V2. In the following, it is assumed, as an example, that first comparator unit 15 forms the difference Δ=R1−V1 and relays it to correction unit 25 if third controlled switch 100 is closed. It is furthermore assumed that second comparator unit 20 forms the quotient Q=R2/V2 and relays it to correction unit 25 as the comparison result if fourth controlled switch 105 is closed. Correction unit 25 forms first correction value KO for the offset of drift characteristics curve 110 and second correction value KS for the slope of drift characteristics curve 110 from difference Δ, quotient Q, and first offset value O1 of the reference characteristics curve of the air mass flow meter with the aid of a system of equations. The system of equations is the following:

KS=1/Q

KO=(1−1/Q)(R1−O1)−Δ

Drift characteristics curve 110 is then corrected with the aid of first correction value KO and second correction value KS by adding the instantaneous offset of drift characteristics curve 110 to first correction value KO to form a new offset for drift characteristics curve 110, and by multiplying the instantaneous slope of drift characteristics curve 110 by second correction value KS to form a new slope for drift characteristics curve 110. In this way, after the correction by using the two correction values KO, KS, there is a new drift characteristics curve 110, which converts signal S of air mass flow meter 1 into the physical quantity of air mass flow LMS.

Alternatively, in the case of a linear reference characteristics curve, first offset value O1 may also be determined by a measurement in the control unit after-run in factory-new condition of air mass flow meter 1, where there is no longer any air mass flow. First offset value O1 is stored in an offset value memory 1000 of device 10 and therefrom supplied to correction unit 25. The output of first reference value memory 70 is also supplied to correction unit 25.

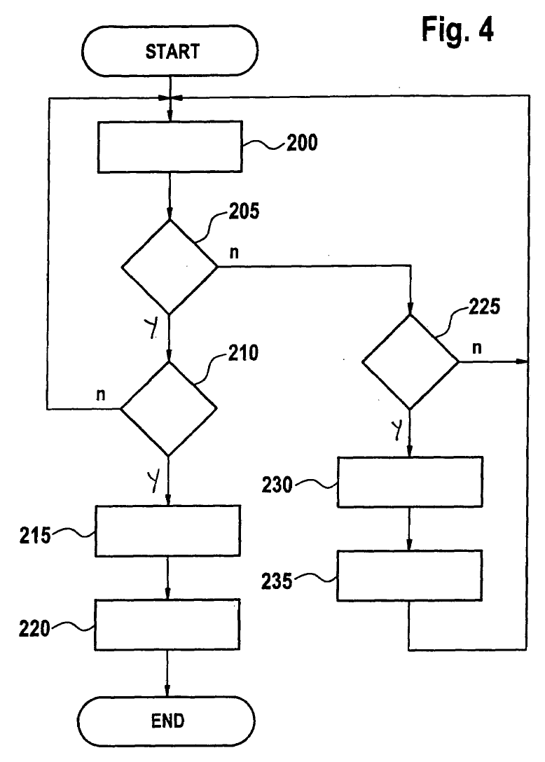

FIG. 4 shows a flow chart for an exemplary sequence of the method according to the present invention as performed by device 10. After the start of the program, at program point 200 operating state detection unit 95 receives instantaneous time t, which has elapsed since the first startup of air mass flow meter 1 or internal combustion engine 5, from time detection unit 90, which was initialized using value t=0 when air mass flow meter 1 or internal combustion engine 5 was first started up. Furthermore, at program point 200, operating state detection unit 95 receives instantaneous engine speed nmot of internal combustion engine 5 from rotational speed sensor 45. Subsequently the program branches off to a program point 205.

At program point 205 a check is performed whether a value has been received from analyzer unit 55 and stored in first reference value memory 70 and second reference value memory 75. It is checked in that first comparator unit 15 checks whether the difference Δ≠zero and in that second comparator unit 20 checks whether the quotient Q≠1. If this is the case, the program branches off to a program point 210; otherwise the program branches off to a program point 225.

At program point 225 operating state detection unit 95 checks whether t<tlimit and nmot<nmotlimit. If this is the case, the program branches off to a program point 230; otherwise the program branches back to a program point 200.

At program point 230, operating state detection unit 95 triggers first controlled switch 60 to connect first output 115 of analyzer unit 55 to first reference value memory 70 and second controlled switch 65 to connect second output 120 of analyzer unit 55 to second reference value memory 75. This results in the instantaneous moving time-average of signal S of air mass flow meter 1 to be written into first reference value memory 70 and the instantaneous signal amplitude of signal S to be written into second reference value memory 75 at next program point 235. The program subsequently branches back again to program point 200.

At program point 210 operating state detection unit 95 checks whether nmot<nmotlimit. If this is the case, the program branches off to a program point 215; otherwise the program branches back to a program point 200. To branch off to program point 215, it is not absolutely necessary for t to be additionally greater than or equal to tlimit. Drift characteristics curve 110 may also be corrected already for times t<tlimit.

At program point 215, operating state detection unit 95 causes both controlled switches 100, 105 to close. The program subsequently branches off to a program point 220.

At program point 220, correction unit 25 ascertains first correction value KO and second correction value KS from input quantities Δ, Q as described above and uses those correction values to correct drift characteristics curve 110 as described above. The program is subsequently terminated.

According to a refinement of the exemplary embodiments and/or exemplary methods of the present invention, it may be provided that correction values KO, KS are only formed in the event of a signal S of air mass flow meter 1 being recognized as plausible, in particular as a function of its variation over time. For this purpose, analyzer unit 55 performs a plausibility check of signal S. For example, analyzer unit 55 may check whether a non-uniform amplitude change of signal S has occurred due to a leak in one of the cylinders of cylinder bank 40. Such a non-uniform amplitude change may be established by analyzer unit 55 if, within a cylinder cycle including two crankshaft revolutions, the amplitude of signal S has a fluctuation width greater than a predefined value which may be suitably calibrated, for example on a test bench, in such a way that it may distinguish the amplitude change of signal S due to a leak in one of the cylinders in cylinder bank 40 from a relatively smaller amplitude change resulting from installation tolerances and aging effects alone without a cylinder leak. Analyzer unit 55 then outputs a plausibility signal P to operating state detection unit 95 as a function of this plausibility check. If plausibility information P is set, it indicates a plausible signal S; otherwise, i.e., if signal S is reset, it indicates an implausible signal S. In the case of an implausible signal S, operating state detection unit 95 causes both controlled switches 100, 105 to open to prevent erroneous correction of drift characteristics curve 110. In contrast, if plausibility information P is set, the opening and closing state of both controlled switches 100, 105 are a function of time t and engine speed nmot or only of engine speed nmot as described previously.

It was assumed here as an example that drift characteristics curve 110 is linear. In general, however, drift characteristics curve 110 is not linear, but it may be roughly approximated by a linear characteristics curve, especially in the case of the ultrasonic air mass flow meter. In the case of a hot film air mass flow meter, such a linearization of drift characteristics curve 110 may occasionally not be advisable, so that in this case drift characteristics curve 110 must be linearized differently, at least in some ranges. In this case it may be provided that analyzer unit 55 additionally checks in which range of the characteristics curve received signal S of air mass flow meter 1 is located; this information may also be communicated to operating state detection unit 95 via a signal B.

In this case, for each of the above-mentioned ranges of the signal quantity which are represented, differently linearized, by drift characteristics curve 110, a system having a first reference value memory, a first comparison value memory, a first comparator unit, and a second reference value memory, a second comparison value memory, a second comparator unit, and a correction unit is provided for correcting the particular linearized range of the signal quantity in drift characteristics curve 110 using one correction value for offset and one correction value for slope. Operating state detection unit 95 must then switch over between the individual systems having the two reference value memories, the two comparison value memories, the two comparator units, and the correction unit depending on the instantaneous signal range, operating state detection unit 95 receiving the instantaneous signal range by signal B as described above. The location of the switches to be installed accordingly is labeled by reference numeral 125 in FIG. 3 and is between first controlled switch 60 and first reference value memory 70, between first controlled switch 60 and first comparison value memory 80, between second controlled switch 65 and second reference value memory 75, and between second controlled switch 65 and second comparison value memory 85. These additional switches 125 are triggered by operating state detection unit 95 as indicated by a dashed line in FIG. 3.

It is self-evident that the correction of drift characteristics curve 110 by correction unit 25 or the correction of a range of drift characteristics curve 110 by the appropriate associated correction unit for an instantaneously received signal value of air mass flow meter 1 cannot be performed until the corresponding comparison value memories 80, 85 have been filled as a function of this instantaneous signal value S, appropriate comparison results A, Q have been formed by comparator units 15, 20, and these have been converted by the associated correction unit 25 into appropriate correction values KO, KS. For this purpose, it may also be provided that a suitable timing of the input of the comparison values into comparison value memories 80, 85, comparator units 15, 20, and the associated correction unit 25, for example, on the part of operating state detection unit 95 is performed, in a first time cycle comparison value memories 80, 85 being overwritten, in a subsequent second time cycle comparator units 15, 20 ascertaining and outputting comparison results Δ, Q, and in a subsequent third time cycle correction unit 25 ascertaining correction values KO, KS and relaying them to drift characteristics curve 110 for correction. This time sequence from overwriting comparison value memories 80, 85 until the correction of drift characteristics curve 110 should take place within the time interval between two consecutively ascertained measured values of air mass flow meter 1.

The above-described method and the above-described device are described as examples on the basis of the drift compensation of an air mass flow meter 1. Similarly, the drift of any other sensors of internal combustion engine 5, for example, a pressure sensor, a temperature sensor, or a rotational speed sensor may also be compensated, but also of sensors that are not installed in an internal combustion engine 5 and detect physical quantities such as, for example, pressure, temperature, mass flow, rotational speed, or the like.

Depending on the sensor used, at least one characteristic quantity of the sensor signal is compared to a reference value and the sensor signal is corrected as a function of the comparison result. A value of the at least one characteristic quantity of the sensor signal derived from the sensor signal is formed as the reference value. In the above-described example, the time-average and the signal amplitude were selected as characteristic quantities of the sensor signal of air mass flow meter 1. For example, if the characteristics curve of the sensor is a function of a single quantity, i.e., it always has a fixed offset value and drifts only with respect to the slope or always has a fixed slope and drifts only with respect to the offset, then it is sufficient if a value derived from the sensor signal is formed for a single characteristic quantity of the sensor signal as the reference value, for example, only the time-average or only the signal amplitude. In particular in the case of non-linear sensor characteristics curves, it may, however, also be necessary to form a value derived from the sensor signal for more than two characteristic quantities of the sensor signal as the reference value. The second time derivative of the signal may serve this purpose, for example, in addition to the time-average and the signal amplitude.

FIG. 2 shows such a non-linear characteristics curve X as a dashed curve divided into four linearized ranges. Signal S may be located in one of these four ranges depending on its magnitude. The four ranges are defined as follows:

### 0<=S<S1

### S1≦=S<S2

### S2≦=S<S3

### S3<=S.

A system of a first reference value memory, a first comparison value memory, a first comparator unit, a second reference value memory, a second comparison value memory, a second comparator unit, and a correction unit as depicted in FIG. 3 is associated with each of these four ranges and is connectable via switching points 125 indicated in FIG. 3.

It was described as an example above that reference value memories 70, 75 may be written to only if t<tlimit. Additionally or alternatively, reference value memories 70, 75 may, however, also be written to or overwritten in another predefined operating state of the air mass flow meter. Such a predefined operating state is characterized in that air mass flow meter 1 is not soiled and free from aging effects or wear in this operating state. This may also be the case after air mass flow meter 1 has been serviced. Therefore, tlimit may also be interpreted as the limit time after air mass flow meter 1 has been suitably serviced. A predefined operating state of air mass flow meter 1 without soiling, aging effects, or wear may also be established by a plausibility check of air mass flow meter 1, for example, with the aid of a redundant air mass flow meter or in any other way as known to those skilled in the art, for example, also by modeling the signal of the air mass flow meter from other performance quantities of internal combustion engine 5; reference value memories 70, 75 may also be written to or overwritten in such a predefined operating state of air mass flow meter 1 as long as the condition for the engine speed nmot<nmotlimit is met.

Drive unit 5 does not have to be designed as an internal combustion engine as described above, but may also be designed as a hybrid drive having an internal combustion engine and an electric motor or as an electric motor or in any other way as known to those skilled in the art; the drift of a sensor of this drive unit may be compensated as described above.

Furthermore, the plausibility check of signal S as a function of its variation over time has been described as an example. However, the plausibility check may be performed in any other way as known to those skilled in the art, for example, via a plausibility check of a characteristic quantity of the sensor signal, the time-average or the signal amplitude, for example. In this way, in the case of a non-uniform amplitude change due to a leak in a cylinder of cylinder bank 40, for example, an implausible characteristic quantity of sensor signal S, for example of the time-average or the signal amplitude, would result. This means that the characteristic quantity would have an impermissible deviation from an expected value. The time-average of signal S would thus have an impermissible deviation from an expected time-average or the signal amplitude of signal S would have an impermissible deviation from an expected signal amplitude.

Reference value memories 70, 75 and comparison value memories 80, 85 may be designed as EEPROMs for example.

1-10. (canceled)

11. A method for correcting a signal of a sensor, the method comprising:
comparing at least one characteristic quantity of the signal of the sensor with a reference value;
correcting the signal of the sensor as a function of a comparison result; and
determining a reference value for the at least one characteristic quantity of the signal of the sensor from the signal of the sensor;
wherein the at least one characteristic quantity of the signal of the sensor includes a signal amplitude.

12. The method of claim 11, wherein the reference value is formed in a predefined operating state of the sensor, within a predefined time after the sensor is put in service for the first time.

13. The method of claim 11, wherein a performance quantity of a drive unit is detected by the sensor and at least one of the reference value and the at least one characteristic quantity of the signal of the sensor is formed for comparing with the reference value in at least one predefined operating state of the drive unit.

14. The method of claim 11, wherein the sensor includes at least one of a hot film air mass flow meter and an ultrasonic air mass flow meter.

15. The method of claim 11, wherein a time-average is selected as another characteristic quantity of the signal of the sensor.

16. The method of claim 11, wherein at least one correction value, which is used to correct the signal of the sensor, is formed as a function of a comparison result.

17. The method of claim 16, wherein the at least one correction value is formed only if a signal of the sensor is recognized as plausible as a function of its variation over time.

18. The method of claim 16, wherein the at least one correction value is formed as a correction value for at least one of an offset and a sensitivity of the signal of the sensor.

19. The method of claim 16, wherein the at least one correction value is formed differently in different ranges of a signal quantity.

20. A device for correcting a signal of a sensor, comprising:
at least one comparator unit to compare at least one characteristic quantity of the signal of the sensor with a reference value;
a correction unit to correct the signal of the sensor as a function of a comparison result; and
a determining arrangement to determine a reference value a reference value of the at least one characteristic quantity of the signal of the sensor from the signal of the sensor;
wherein the at least one characteristic quantity of the signal of the sensor includes a signal amplitude.
